(19) United States
(12) Patent Application Publication
(10) Pub. No.: US 2005/0280910 A1
(43) Pub. Date: Dec. 22, 2005

(54) Method for the targeted deformation of an optical element

(76) Inventors: Jean Noel Fehr, Pully (CH); Johannes Lippert, Buch a W. (DE); Steffen Fritzsche, Aalen (DE); Michael Muehlbeyer, Aalen (DE); Harald Kirchner, Munchen (DE)

Correspondence Address: Donald S. Showalter;Holland & Knight LLP, One East Broward Boulevard, Suite 1300, P.O. Box 14070, Ft. Lauderdale, FL, 33302-4070, US

(21) Appl. No.: 10/992,310

(22) Filed: Nov. 18, 2004

Related U.S. Application Data
(63) Continuation-in-part of application No. PCT/EP03/05113, filed on May 15, 2003.

(30) Foreign Application Priority Data
May 18, 2002 (DE) DE 102 22 331.9

(51) Int. Cl. G02B 7/02

(52) U.S. Cl. 359/825

(57) ABSTRACT

The invention relates to a method for the targeted deformation of an optical element, in particular a mirror that is positioned in an optical system. The optical element or a support element, on which the optical element is placed in such a way that forces acting on the support element cause a deformation of the optical element itself, are connected to a fixed structure indirectly by means of fixing elements or connecting members. The desired deformation of the optical element is achieved by a targeted variation of the fixing elements to modify the forces exerted in the fixing process on the optical element or the support element and/or the action of the moment of force and/or torque of the connecting members on the fixing elements.

### PRIORITY CLAIM

Priority under 35 U.S.C. §365(c) is hereby claimed to PCT/EP03/05113 filed May 15, 2003 which claims priority to German Patent Application No. DE 102 22 331.9, filed May 18, 2002.

### BACKGROUND OF THE INVENTION

1.74 Field of the Invention

The invention relates to a method for the targeted deformation of an optical element, in particular a mirror, that is arranged in an optical system, the optical element or a carrier element, on which the optical element is mounted in such a way that forces acting on the carrier element cause a deformation of the optical element itself, being connected via fastening means directly or via joining means to a fixed structure. The invention also relates to a method for adjusting an optical element in accordance with the preamble of Claim 16.

2. Description of the Related Art

Aberrations caused, for example, by heat, environmental conditions, positional deviations of mirrors, deviation in the shape of the optical surface from the desired shape, by layer stresses and tightening torques of screws, deformations induced in mounts and by manufacturing defects substantially impair the image quality of an optical system, for example of a projection exposure machine for microlithography. These problems are particularly compounded in the EUV region, where manipulators and the optical system are no longer adequately decoupled. An aberration correction, for example in order to balance out manufacturing inaccuracies in the projection objective is carried out by means of manipulating the optical elements via special manipulators or actuators. The disadvantage of this is that the very movements of the manipulator do not generally act on the optical element in a fashion free from deformation. The aberrations owing to the parasitic deformation of the surface of the optical element on the basis of the manipulator movements could in individual cases even be greater than the aberrations that were actually to be corrected by the movement. There is the risk that adjusting the objective without taking account of these deformations is no longer reliably possible. These problems are further compounded by so-called parasitic movements of the manipulators, that is to say by undesired additional movements of the manipulators, in particular in other degrees of freedom. The adjustment process of the newly fabricated projection objective is thereby rendered substantially longer and more complicated.

Also known to date are measures for correcting aberrations that are based on the introduction of forces or torques to optical elements, particularly mirrors. In the case of all previously used optical elements and mounts, this introduction of forces or torques is always performed via actuators, adjusting screws or the like that are specifically designed therefor.

However, with regard to the required design space in the objectives or imaging devices, this frequently constitutes a very complicated and expensive solution that causes a not inconsiderable outlay on construction if the aim is to find room in the objective for all requisite components for the purpose. Moreover, it must be ensured that all adjusting screws also remain accessible for manipulation or that, in the case of the use of actuators, there is always the possibility of electrical, pneumatic or other connection to an actuating medium.

### SUMMARY OF THE INVENTION

It is therefore the object of the present invention to provide methods of the type mentioned at the beginning that cancel the disadvantages of the prior art, the particular aim being to enable targeted correction of aberrations of an optical system in an adjustment process that is as simple and short as possible by means of accurate manipulations and/or targeted deformations of the optical elements, in which case the use of special and expensive actuators is to be dispensed with for this purpose.

This object is achieved according to the invention by means of the characterizing features of claim 1. It is likewise achieved by means of the features of claim 9 and it is likewise achieved by means of the features of claim 16.

Forces and/or torques are introduced in a simple and advantageous way by means of these measures in the region of holding means, such as clamps, adhesives or screws, that are required in any case for fastening optical elements, for the purpose of targeted deformation of the optical element. This saves the use of complicated actuators whose main function would be to deform the optical element. There is no need for additional design space, and no additional substantial outlay on construction is caused. Consequently, manipulation of an active optical element is enabled in a favorable way.

It is advantageous when the image of the optical system in the image plane or on the substrate stage is influenced by the targeted deformation of the optical element, and aberrations of the optical system in the image plane or on the substrate stage are removed at least approximately by the targeted deformation of the optical element.

Consequently, a simple method is provided for compensating aberrations of an optical system without high outlay by deformations of an optical element. This can be performed without high outlay only with the aid of the holding and/or fastening elements required in any case by the optical element.

It is advantageous when a mirror is used as optical element. Both coated and uncoated mirrors can be deformed to correct the aberrations of an optical system. It is also possible to use a reticle mask as optical element.

Advantages with reference to claim 8 result from the fact that the optical element can advantageously be adjusted more accurately and more quickly with incorporation of the additional parasitic effects to be expected from the manipulation itself.

Advantageous refinements and developments of the invention follow from the further subclaims and from the exemplary embodiments described in principle in what follows with the aid of the drawings.

### BRIEF DESCRIPTION OF THE DRAWINGS

FIG. 1 shows a sketch of the principle of an optical system having six mirrors;

FIG. 2 shows a plan view of a mirror having a carrier element;

FIG. 3 shows a side view of a mirror with a link to a fixed structure in a first embodiment;

FIG. 4a shows a side view of a mirror with a link to a fixed structure in a second embodiment by means of a manipulator;

FIG. 4b shows a further side view of a mirror with a link to a fixed structure in a second embodiment by means of a manipulator;

FIG. 5 shows a graphical representation of a possible deformation of the optical surface of a mirror;

FIG. 6a shows a sketch of the principle of a parasitic movement of a Z manipulator;

FIG. 6b shows a compensation of the parasitic movement of the Z manipulator from FIG. 6a by means of a movement in x- and in rotx-directions; and

FIG. 7 shows a design principle of an EUV projection exposure machine having a light source, an illumination system and a projection objective.

### DETAILED DESCRIPTION

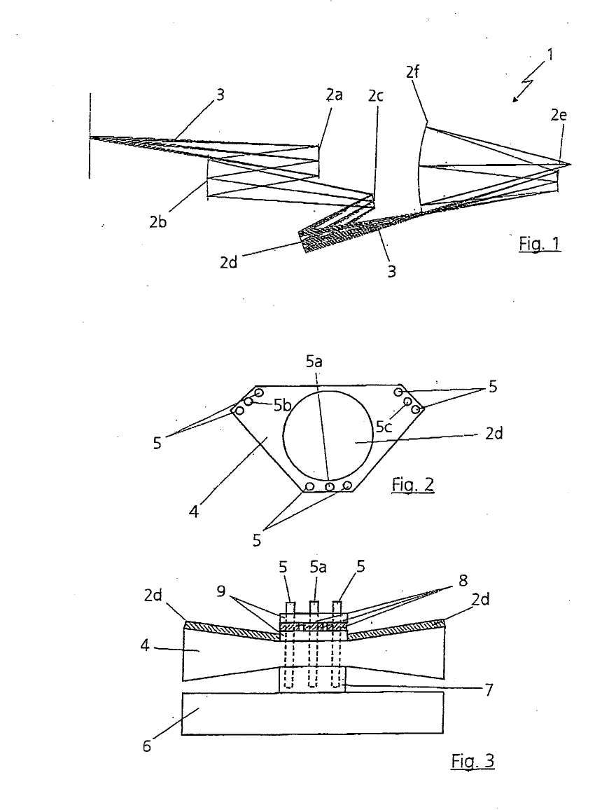

As may be seen from FIG. 1, an optical system 1 has six mirrors 2a, 2b, 2c, 2d, 2e, 2f. The beam path 3 of the light is sketched in principle. As illustrated in FIG. 7, such an optical system 1 can be used as projective objective 1 in an EUV projection exposure machine 11 for microlithography.

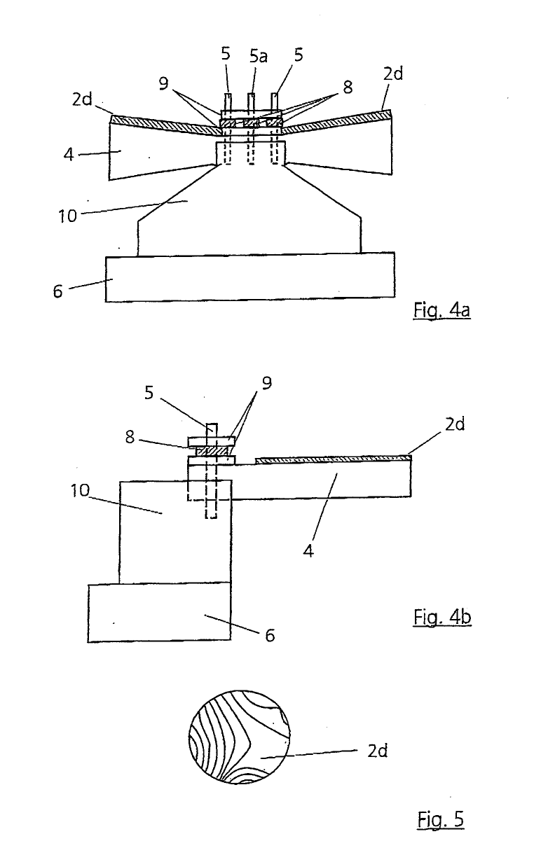

FIG. 2 shows the mirror 2d, which is fastened on a carrier element 4. In the present exemplary embodiment, the carrier element 4 is connected directly (FIG. 3) or via manipulators 10 (FIGS. 4a and 4b) via screws 5, 5a, 5b, 5c to a fixed structure 6 that is illustrated in more detail in FIGS. 3, 4a and 4b, and can be a fixed part of the projection exposure objective. It is particularly important that a fixed connection not decoupled with regard to forces exists between the mirror 2d, that is to say the optically active surface, and the carrier element 4. It would be optimal to use a single block mirror, however, it is likewise possible to bond the mirror 2d onto the carrier element 4 although this is attended by a corresponding damping of the force actions. The forces, stresses and torques occurring during tightening of the screws 5, 5a, 5b, 5c for the carrier element 4 are consequently passed on to the mirror 2d. These forces, stresses and torques are actively used in order to manipulate and/or deform the mirror 2d or the optically active surface thereof indirectly via the carrier element 4 so as to reduce aberrations of the optical system 1. In addition to the simple possibility of modifying the tightening torque of the individual screws 5, 5a, 5b, 5c, there is the possibility, in addition, of achieving this via active elements, in particular longitudinally modifiable actuators such as piezoelectric stacks. Such a mode of operation is outlined in FIGS. 3, 4a and 4b in particular.

As may be seen from FIG. 3, the mirror 2d is mounted on the carrier element 4 and connected to the fixed structure 6 via screws 5, 5a by means of a mount 7. Piezoelectric elements 8 are inserted between metal shins 9 and around the screws 5, 5a in such a way that given a modification of the length of the piezoelectric elements 8 in the direction of the carrier element 4 the pressure exerted thereon strengthens the holding or clamping force of the screws 5, 5a and therefore introduces forces onto the carrier element 4 with the mirror 2d. In order to modify the holding or clamping force of the screws 5, 5a, it is also possible, of course, in another exemplary embodiment to use other means than piezoelectric elements 8. The electrical connections of the piezoelectric elements 8 are not illustrated. Consequently, the force can easily and advantageously occur in the region of the screws 5, 5a required in any case for fastening the carrier element 4 with the mirror 2d on the mount 7 or the fixed structure 6.

In FIGS. 4a and 4b a manipulator 10 ensures that the carrier element 4 with the mirror 2d is linked to the fixed structure 6. Manipulators 10 permit the translatory and rotary motion of the carrier element 4 with the mirror 2d. In addition, the manipulator 10 can also be used in order to exert forces or torques on the screws 5, 5a or on the carrier element 4, and thus on the mirror 2d.

FIG. 4b shows a side view of the embodiment illustrated in FIG. 4a.

FIG. 5 illustrates by way of example a possible form of the deformation of the optically active surface of the mirror 2d after introduction of forces.

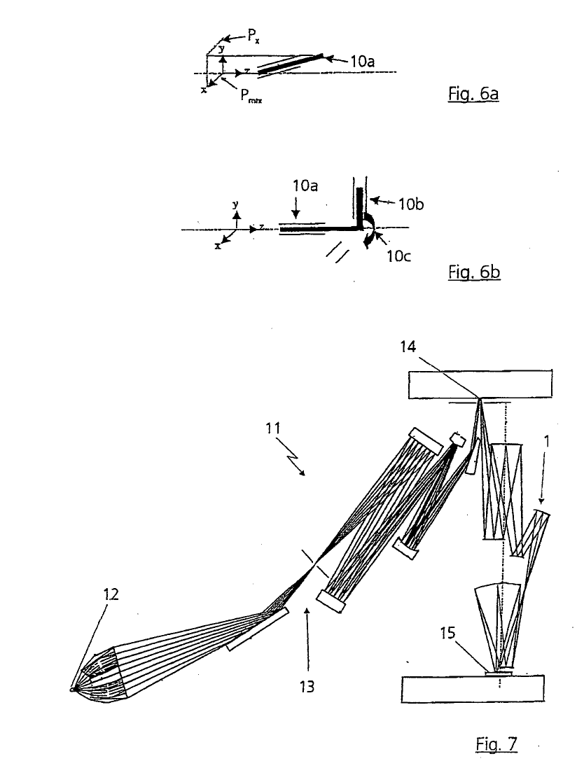

FIG. 6a shows parasitic movements of a Z manipulator 10a: undesired movements occur in the X-direction Pₓ and in the rotX-direction Pᵣₒₜₓ. For this purpose, use was made in the present exemplary embodiment of a X-manipulator 10b and a rotx-manipulator 10c for compensating the parasitic movements Pₓ, Pᵣₒₜₓ (FIG. 6b). It is advantageously possible in further exemplary embodiments to use the remaining manipulators 10, in particular in 5 degrees of freedom, for compensating the parasitic movements of a manipulator 10.

As may be seen from FIG. 7, the EUV projection exposure machine 11 has a light source 12, an EUV illumination system 13 for illuminating a field in a plane 14 in which a structure-bearing mask is arranged, as well as the projection objective 1 for imaging the structure-bearing mask in the plane 14 onto a photosensitive substrate 15. Reference may be made to EP 1 123 195 A1 as regards the EUV illumination system 13.

The main aim of the deformations and movements caused by the introduction of forces or torques via the screws 5, 5a, 5b, 5c or the manipulators 10 is to balance out aberrations of the optical system 1. Such aberrations are produced, for example, by manufacturing inaccuracies (shape errors—deviation of the shape of the optical surface from the desired shape, deformations induced by layer stresses, deformations caused by screw tightening torques), positional deviations, heat and environmental conditions. This main aim is intended to be achieved by introducing forces onto the mirror 2d or the carrier element 4 thereof, or by moving the mirror 2d or the carrier element 4 thereof by the manipulators 10 in all 6 degrees of freedom. In order to correct aberrations, the image of the optical system 1 in the image plane or on a substrate stage is influenced by deformations produced in the optical surface of the mirror 2d and by a possible change in tilting/position. It is also possible to correct short term aberrations caused by heat or temperature variations in the environment. It is true that the deformations induced by the manipulators 10 or the screws 5, 5a, 5b, 5c likewise constitute perturbations of the optical system 1, but these, as it were, artificial perturbations or their strength or amplitude can be controlled. For this reason, these controlled deformations constitute a very effective means of improving the image quality or of adapting the properties of the optical system 1. Consequently, these controlled deformations caused by the tightening torque of the screws 5, 5a, 5b, 5c and by the action of force or the action of torque on the manipulators 10 form degrees of freedom for correcting the aberrations in the optical system 1. It is conceivable to use a described method both for correcting static aberrations when adjusting the optical system 1, and for correcting dynamically occurring aberrations (for example owing to heat, temperature drift, or the like). As already addressed above, there is still the problem of parasitic effects of the manipulators 10 which occur in an undesired fashion in addition to the targeted movements and actions of forces and torques. Both additional induced deformations and movements along other directions are involved here. The aberrations owing to the parasitic deformation of the surface of the optical elements could even become greater in individual cases than the aberrations that are actually to be corrected by the movement. These parasitic effects of the manipulators 10 (and also, possibly, of the screws 5, 5a, 5b, 5c) are now also already incorporated, according to the invention, in the calculation of the adjusting positioning travels and in selection of the manipulators 10 or the screws 5, 5a, 5b, 5c to be readjusted, that is to say they are incorporated in the adjustment algorithm. This integration is enabled by a mathematical description. The aberrations of the optical system 1 can be determined from a measured image, and the requisite movements of the manipulators 10 can be calculated. The deformations to be expected of the optical surfaces are indicated in the adjustment algorithm as pseudo-manipulators coupled to the real manipulators 10, as it were.

The deformations produced in a targeted manner on the optical surface cover the nanometer range (for a force of 1 N and torques of 10 Nmm at the manipulators 10) and permit virtually all types of corrections of aberration. Rotationally symmetrical deformations for example can be produced by the use of the manipulators 10 or by the variation of the screws 5, 5a, 5b, 5c which, as illustrated in FIG. 2, are arranged approximately symmetrically about the mirror 2d on the carrier element 4. These are, for example, changed in radius in the x- or y-direction owing to radial compression of the carrier element 4 with the mirror 2d (astigmatism for the correction of image offset). The correction of three-leaf clover can be performed, for example, by torques introduced onto the mirror 2d. Of course, a symmetrical arrangement is not mandatory. Asymmetric aberrations could also be corrected with the aid of an asymmetric arrangement of the manipulators 10 or of the screws 5, 5a, 5b, 5c.

The following method is applied to correct the aberrations in the optical system 1:

in a first step, there is an analysis of the modifications, with reference to the image or the aberrations, that can be induced by the screws 5, 5a, 5b, 5c and also by the manipulators 10 in the image plane or on the substrate stage of the optical system 1;

in a second step, there is an analysis (by calculation, measurement or simulation) of the current perturbations of the optical system 1 in the image plane; and
in a third step there is a minimization of the aberrations determined in step two by means of a linear combination of the inducible image modifications, determined in step 1 with the aid of suitable mathematical methods (for example SVD or the like) in accordance with which the aberrations that are caused by the perturbations of the optical system 1 are corrected by modifications of the forces or torques on the screws 5, 5a, 5b, 5c, the respective intensities or amplitudes of the forces or torques respectively to be used being specified by the coefficients of the linear combination.

The following exemplary embodiment shows that aberrations of the optical system 1 can be corrected, and the optical quality of the system can be improved, with the aid of the variation of the tightening torque of the screws 5a, 5b, 5c of the mirror 2d on the carrier element 4. The modification of the tightening torque of the screws 5a, 5b, 5c is equivalent to a modification of the pressure on the contact point of the screws 5a, 5b, 5c with the carrier element 4 or with the mirror 2d. In this exemplary embodiment, only three screws 5a, 5b or 5c were used as adjustable degrees of freedom, as it were, and it was possible to provide nine degrees of freedom when using all the screws 5, 5a, 5b, 5c. The number of possibilities for reducing the aberrations rises, of course, with the use of as many degrees of freedom as possible.

Only a few specific aberrations were treated by way of example, for the sake of simplicity. These are: distortion (DIST.), field curvature (FC), astigmatism (AST), wave front errors (WFE), coma and spherical aberration (SPA). These aberrations relate largely to the optical system 1.

The above method was used as follows in a first exemplary embodiment:

The tightening torques of the screws 5a, 5b, 5c (see FIG. 2) of the mirror 2d of the optical system 1 were temporarily increased in a first step by 500 N in each case, in order to determine the aberrations inducible thereby.

| | DIST. | FC | AST | WFE | COMA | SPA |
|---|---|---|---|---|---|---|
| Screw 5a | 10.493 | 147,881 | 114.333 | 0.931 | 1.257 | 0.430 |
| Screw 5b | 7.271 | 97.655 | 79.468 | 0.656 | 0.873 | −0.291 |
| Screw 5c | 7.377 | 97.127 | 79.130 | 0.655 | 0.885 | −0.275 |

Subsequently, the aberrations of the optical system 1 were determined in a second step by means of induced perturbations.

| | DIST. | FC | AST | WFE | COMA | SPA |
|---|---|---|---|---|---|---|
| opt. | 5.94 | 102.6 | 80.1 | 0.652 | 0.829 | −0.377 |
| system 1 | | | | | | |

In the last step, a minimization of the aberrations of the optical system 1 determined in step two was calculated by a linear combination of the inducible image modifications determined in step one, this being done by varying the tightening torque of the screws 5a, 5b, 5c by 500 N. The factor specifies the reduction of the respective aberration by the linear combination. The coefficients in front of the reference symbols of the screws 5a, 5b, 5c specify the linear coefficient that is required in order to achieve a minimum aberration. Consequently, the aberrations are minimized for the screw 5a given a strengthening of the tightening torque by 2.9×500 N, the figure for screw 5b being 3.3×500 N, and that for screw 5c being 2.5×500 N.

| | DIST. | FC | AST | WFE | COMA | SPA |
|---|---|---|---|---|---|---|
| 1.44 (5a) + 1.82 | 6.43 | 82.2 | 51.39 | 0.389 | 0.522 | −0.288 |
| (5b) + 0.94 (5c) | | | | | | |
| Factor | 0.9 | 1.2 | 1.6 | 1.7 | 1.6 | 1.3 |
| 2.9 (5a) + 3.3 | 5.1 | 70.9 | 50.7 | 0.398 | 0.557 | −0.318 |
| (5b) + 2.5 (5c) | | | | | | |
| Factor | 1.2 | 1.4 | 1.6 | 1.7 | 1.5 | 1.2 |

In a second exemplary embodiment, an attempt was made to use an appropriate correction of the tightening torques of the screws 5b, 5c in order to balance out the instances of image interference of the optical system 1 caused by an increase in the tightening torque of the screw 5a of the mirror 2d on the carrier element 4.

The effects of the variation of the tightening torque of the screws 5b and 5c by 500 N were determined in the first step in the process.

| | DIST. | FC | AST | WFE | COMA | SPA |
|---|---|---|---|---|---|---|
| Screw 5b | 7.271 | 97.655 | 79.468 | 0.656 | 0.873 | −0.291 |
| Screw 5c | 7.377 | 97.127 | 79.130 | 0.655 | 0.885 | −0.275 |

The aberrations caused by the increase in the tightening torque of the screw 5a were determined in a second step.

| | DIST. | FC | AST | WFE | COMA | SPA |
|---|---|---|---|---|---|---|
| Screw 5a | 10.493 | 147.881 | 114.333 | 0.931 | 1.257 | 0.430 |

A minimization of the error determined in step two was carried out with the aid of the results from step 1 in the third step, once again by means of the linear combination. As in the above exemplary embodiment, the factor specifies the reduction in the respective aberration.

| | DIST. | FC | AST | WFE | COMA | SPA |
|---|---|---|---|---|---|---|
| 5a, 5b, 5c | 1.06 | 25.9 | 11.6 | 0.113 | 0.19 | 0.06 |
| (5a) + 1.036(5b) + | 0.76 | 16.04 | 10.27 | 0.078 | 0.133 | 0.073 |
| 1.037(5c) | | | | | | |
| Factor | 1.4 | 1.6 | 1.1 | 1.4 | 1.4 | 0.8 |

In a third exemplary embodiment, aberration corrections were introduced by manipulators 10 in accordance with FIGS. 4a and 4b. Use was made of eight degrees of freedom in the form of manipulators 10 that act on the points of the screws 5a, 5b. Here, only eight degrees of freedom were used, but when the basis is twelve degrees of freedom per mirror 2a, 2b, 2c, 2d, 2e, 2f the result is a total maximum number of 72 degrees of freedom for the optical system 1 that are admittedly available in principle for correcting aberrations, but of which not all can be used owing to mechanical and physical reasons.

In the first step, the effects of the variation of the actions of the forces of the manipulators on the sites formed by the screws 5a and 5b of the mirror 2d on the carrier element 4 were measured once again. The following forces and torques were fundamentally applied to the mirror 2f in this process: radial force (RF), radial torque (RT), tangential torque (TT), torque along or in the direction of the optical axis (ZT).

| | DIST. | FC | AST | WFE | COMA | SPA |
|---|---|---|---|---|---|---|
| RF 5a 2f | 0.72 | 6.52 | 6.52 | 0.007 | 0.001 | 0.044 |
| RT 5a 2f | 0.56 | 13.98 | 13.98 | 0.002 | −0.0002 | 0.093 |
| TT 5a 2f | 0.11 | 1.38 | 1.35 | 0.008 | 0.001 | 0.013 |
| ZT 5a 2f | 0.02 | 0.57 | 0.56 | 0.001 | 0.0002 | 0.004 |
| RF 5b 2f | 0.88 | 7.11 | 7.11 | 0.007 | 0.003 | 0.048 |
| RT 5b 2f | 0.83 | 15.16 | 15.16 | 0.002 | 0.0004 | 0.100 |
| TT 5b 2f | 0.35 | 3.20 | 3.20 | 0.009 | 0.002 | 0.023 |
| ZT 5b 2f | 0.03 | 0.46 | 0.46 | 0.001 | −0.0001 | 0.003 |

The present image interference of the optical system 1, which were induced by a deformation of the mirror 2d, were determined in the second step.

| | DIST. | FC | AST | WFE | COMA | SPA |
|---|---|---|---|---|---|---|
| 2d | 0.86 | 13.45 | 11.08 | 0.086 | 0.103 | −0.046 |

The optimum image corrections were calculated in the third step on the basis of the manipulations shown in step one.

| | DIST. | FC | AST | WFE | COMA | SPA |
|---|---|---|---|---|---|---|
| Mirror 2d | 0.47 | 9.94 | 4.77 | 0.058 | 0.063 | −0.042 |
| Factor | 1.8 | 1.4 | 2.3 | 1.6 | 1.1 | 1.5 |

Targeted movements of the manipulators can approximately produce changes in radius by 5×10⁻⁸ m Δr/r per mirror 2a, 2b, 2c, 2d, 2e, 2f and thereby correct the following aberrations with orders of magnitude as follows:

2a: 100 Nm FC and AST, and 1 nm coma

2b: negligible

2c: negligible

2d: 200 nm DIST., 300 nm FC and AST, 2 nm WFE, 1 nm coma, 0.2 nm SPA

2e: negligible

2f: 100 nm DIST., 0.2 nm SPA.

There follows an examination of the principle of an adjusting algorithm in which the parasitic effects of the manipulators 10 of an optical system are additionally incorporated into the calculation of the adjusting positioning travels, and into the selection of the manipulators to be readjusted.

Given a perfectly adjusted optical system, a movement of the manipulators produces aberrations by the change in position of the optical elements, on the one hand, and by their deformation, on the other hand. The deformation is a function of the magnitude of the forces and torques that act on the optical elements, and these are a function, in turn, of the setting of the manipulators.

The effects can be described as \overline{b}_{D}=A_{D}·\overline{x} in a linear approximation, \overline{b}_{D} representing the aberrations that result from the pure manipulation \overline{x}. The sensitivity matrix A_{D} produces the relationship between \overline{b}_{D} and \overline{x} in accordance with the design of the optical-system.

In the same way, \overline{b}_{V}=A_{V}·\overline{x} describes the aberrations \overline{b}ᵥ that result from the additional parasitic deformations during the manipulation \overline{x}. Here, the sensitivity matrix A_{V} takes account only of the effects of the additional deformations.

The correction of these aberrations \overline{b}_{V} depending on deformation requires a number of degrees of freedom that can be achieved either by an additional movement of the same manipulator, or by the movement of one or more other manipulators.

An actual effect of a manipulation on the aberrations is yielded by adding the two effects \overline{b}_{D} and \overline{b}_{V}.

$$\overline{b} = {\overline{b}}_{D} + {\overline{b}}_{V} = ( {A}_{D} + {A}_{V} ) \cdot \overline{x} = A \cdot \overline{x} , A = ( \begin{matrix}{a}_{1 , 1} & {a}_{1 , 2} & ⋯ & {a}_{1 , m} \\ {a}_{2 , 1} & {a}_{2 , 2} & ⋯ & {a}_{2 , m} \\ ⋮ & ⋯ & ⋯ & ⋮ \\ {a}_{n , 1} & {a}_{n , 2} & ⋯ & {a}_{n , m}\end{matrix} )$$

a_{1,1} to a_{a,m} represent the factors determined for the purpose of describing the relationship between the positioning travels to be covered and the aberrations resulting therefrom.

The actual adjustment problem can be solved in a known manner by means of singular-value analysis methods.

The fact that the imaging optics for EUV lithography place extremely stringent requirements on the image quality and thus on the magnitude of the residual errors requires the use of very many manipulators. Consequently, all the optical elements (except for the reference element) are manipulated in all six degrees of freedom. However, in conjunction with a finite measuring accuracy of the aberrations this can lead to instabilities in the method, resulting, for example, in extremely high positioning travels (possibly not capable of implementation) of some manipulators, while others would not be moved at all. According to the prior art, it would therefore be necessary to select manipulators. In other words, attempts would be made to use a minimum number of manipulators sufficient for adjustment, while other manipulators carrying out similar tasks would be ignored. However, the residual level of the aberrations after adjustment would thereby be raised and in some circumstances precisely the manipulators ignored for a specific problem would be decisive, in particular given the stringent requirements in the EUV field.

The inventors solve this contradiction by means of a so-called self-conditioning method that avoids instabilities and at the same time uses all the manipulators. For this purpose the matrix A is expanded to Aₛₖ so that the positioning travels are shifted to the aberration side.
G·\overline{b}ₛₖ=G·Aₛₖ·\overline{x}, where

$${A}_{sk} = ( \begin{matrix}{a}_{1 , 1} & {a}_{1 , 2} & ⋯ & {a}_{1 , m - 1} & {a}_{1 , m} \\ ⋮ & ⋯ & ⋯ & ⋯ & ⋮ \\ {a}_{n , 1} & {a}_{n , 2} & ⋯ & {a}_{n , m - 1} & {a}_{n , m} \\ 1 & 0 & ⋯ & 0 & 0 \\ ⋮ & ⋯ & ⋯ & ⋯ & ⋮ \\ 0 & 0 & ⋯ & 0 & 1\end{matrix} ) , \\ {\overline{b}}_{sk} = ( \frac{\overline{b}}{0} ) , G = ( \begin{matrix}{g}_{1} & ⋯ & 0 & 0 & ⋯ & 0 \\ ⋮ & ⋯ & ⋯ & ⋯ & ⋯ & ⋮ \\ 0 & ⋯ & {g}_{n} & 0 & ⋯ & 0 \\ 0 & ⋯ & 0 & {g}_{n + 1} & ⋯ & 0 \\ ⋮ & ⋯ & ⋯ & ⋯ & ⋯ & ⋮ \\ 0 & ⋯ & 0 & 0 & ⋯ & {g}_{n + m}\end{matrix} )$$

That is to say, an aberration vector \overline{b}ₛₖ expanded by the positioning travels is defined. At the same time, weighting factors gᵢ that permit positioning travels and aberrations to be weighted at different strengths are introduced. If a measurement of the aberrations is now expanded by the positioning travels 0, optimization by means of singular-value analysis yields a result that automatically uses only those ones of all manipulators that lead in specific instances to an improvement of the aberrations, and simultaneously require manipulator paths (positioning travels) that are as small as possible. All the optical elements (apart from the reference element) can be used in this way for manipulation and simultaneously ensure a stable process. The optimum selection of the weighting factors gᵢ has proved to be very important in practice. If a measurement of the aberrations is expanded by the deflection of the manipulators, then optimization by means of singular-value analysis yields a result that automatically minimizes the absolute deflection of the manipulators in addition to minimizing the aberrations. This ensures observance of the physically possible positioning ranges of the manipulators (range control).

1. A method for the targeted deformation of an optical element arranged in an optical system, said optical element or a carrier element, on which said optical element is mounted in such a way that forces acting on said carrier element cause a deformation of said optical element itself, being connected via fastening means to a fixed structure, wherein the desired deformation of said optical element is achieved by a targeted variation of said fastening means in order to modify the forces, applied for fastening, on said optical element or said carrier element.

2. The method as claimed in claim 1, wherein said optical element or said carrier element is connected via joining members and fastening means to the fixed structure and wherein the desired deformation of said optical element is supported by a targeted variation of the action of forces and/or torques of said joining members on the fastening means.

3. The method as claimed in claim 2, wherein said joining members for connecting said optical element or said carrier element to the fixed structure are designed as manipulators.

4. The method as claimed in claim 1 or 2, wherein the image of the optical system in the image plane is influenced by the targeted deformation of said optical element.

5. The method as claimed in claim 4, wherein aberrations of the optical system in the image plane are at least approximately removed by a targeted deformation of a said optical element.

6. The method as claimed in claim 1, wherein said fastening means are connected to said optical element or said carrier element via components of variable length.

7. The method as claimed in claim 6, wherein screws are used as said fastening means, said components of variable length, via which said screws are connected to said optical element or said carrier element being designed as piezoelectric elements in the form of shims, the thickness of said piezoelectric elements being modified to vary the force for fastening said optical element or said carrier element, and thus to deform said optical element.

8. The method as claimed in claim 5, wherein
in a first step the modifications that can be induced by said joining members and/or said fastening means of said optical element in the image plane of the optical system are analyzed with reference to the image or the aberrations of the optical system;
in a second step the perturbations of the optical system in the image plane are analyzed and the aberrations are determined; and
in a third step the aberrations determined in the second step are minimized by a linear combination of the induced image modifications, analyzed in the first step, with the aid of suitable mathematical methods in accordance with which the aberrations that are caused by the perturbations of the optical system are corrected by the modifications of the forces or torques on said fastening means of said optical element and/or by modifying the forces or torques of said fastening means and/or by modifying the forces or torques of said joining members, the coefficients of the linear combination specifying the intensities or amplitudes of the forces or torques respectively to be used.

9. A method for the targeted deformation of an optical element arranged in an optical system, said optical element or a carrier element, on which said optical element is mounted in such a way that forces acting on said carrier element cause a deformation of said optical element itself, being connected via fastening means and joining members to a fixed structure, wherein the desired deformation of said optical element is achieved by a targeted variation of the action of forces and/or torques of said joining members on the fastening means.

10. The method as claimed in claim 9, wherein said joining members for connecting said optical element or said carrier element to the fixed structure are designed as manipulators.

11. The method as claimed in claim 9, wherein the image of the optical system in the image plane is influenced by the targeted deformation of said optical element.

12. The method as claimed in claim 11, wherein aberrations of the optical system in the image plane are at least approximately removed by the targeted deformation of said optical element.

13. The method as claimed in claim 9, wherein said fastening means are connected to said optical element or said carrier element via components of variable length.

14. The method as claimed in claim 13, wherein screws are used as said fastening means, said components of variable length, via which said screws are connected to said optical element or said carrier element being designed as piezoelectric elements in the form of shims, the thickness of said piezoelectric elements being modified to vary the action of force for fastening said optical element or said carrier element, and thus to deform said optical element.

15. The method as claimed in claim 12, wherein
in a first step the modifications that can be induced by said joining members and/or said fastening means of said optical element in the image plane of the optical system are analyzed with reference to the image or the aberrations of the optical system;
in a second step the perturbations of the optical system in the image plane are analyzed and the aberrations are determined; and
in a third step the aberrations determined in the second step are minimized by a linear combination of the induced image modifications, analyzed in the first step, with the aid of suitable mathematical methods in accordance with which the aberrations that are caused by the perturbations of the optical system are corrected by the modifications of the forces or torques on said fastening means of said optical element and/or by modifying the forces or torques of said joining members, the coefficients of the linear combination specifying the intensities or amplitudes of the forces or torques respectively to be used.

16. A method for adjusting an optical element being arranged in an optical system, said optical element or a carrier element, on which said optical element is mounted in such a way that forces and moments acting on said carrier element cause a deformation of said optical element itself, being connected via manipulators to a fixed structure, said optical element being adjusted by readjusting said manipulators, wherein the deformations of optical surfaces of said optical element to be expected from the movements of said manipulators are already incorporated before the adjustment process in an algorithm for calculating the requisite positioning travels of said manipulators for adjusting said optical element.

17. The method as claimed in claim 16, wherein parasitic movements of one of said manipulators during the adjustment of said optical element are compensated by an additional movement of said manipulator.

18. The method as claimed in claim 16, wherein parasitic movements of one of said manipulators during the adjustment of said optical element are compensated by a readjustment of further said manipulators in a number of degrees of freedom.

19. The method as claimed in claim 16, 17 or 18, wherein said optical element is manipulated in six degrees of freedom by said manipulators.

20. The method as claimed in claim 16, wherein said algorithm for calculating the requisite positioning travels of said manipulators minimizes the positioning travels of said manipulators with the aid of weighting factors to be prescribed.

21. The method as claimed in claim 16, wherein said algorithm for calculating the requisite positioning travels of said manipulators optimizes the adjustment process with the aid of weighting factors to be prescribed.

22. A method for adjusting an optical system comprising a number of optical elements, said optical elements being connected via manipulators to a fixed structure, in which the optical system is adjusted by adjusting at least one optical element using the method in accordance with claim 16.

23. The method as claimed in claim 22, which is used to correct aberrations of the optical system.

24. The method as claimed in claim 1, 9 or 22, wherein the optical system is a projection objective in a projection exposure apparatus for microlithography in order to produce microelectronic components, in particular semiconductor components.

25. Projection objective comprising a number of optical elements which is adjusted by adjusting at least one of said optical elements using the method according to claim 16.

26. The projection objective as claimed in claim 25, wherein said at least one optical element is a mirror.

27. The projection objective as claimed in claim 25, wherein said at least one optical element is an end plate.

28. Projection objective comprising a number of optical elements, wherein aberrations in the image plane of the projection objective are removed using the method according to claim 1.

29. The projection objective as claimed in claim 28, wherein said at least one optical element is a mirror.

30. The projection objective as claimed in claim 28, wherein said at least one optical element is an end plate.

31. Projection objective comprising a number of optical elements, wherein aberrations in the image plane of the projection objective are removed using the method according to claim 9.

32. The projection objective as claimed in claim 31, wherein said at least one optical element is a mirror.

33. The projection objective as claimed in claim 31, wherein said at least one optical element is an end plate.

34. Microlithography projection exposure apparatus for the production of semiconductor components comprising a projection objective according to any of claims 25 to 33.
